(19) United States
(12) Patent Application Publication
(10) Pub. No.: US 2020/0144845 A1
(43) Pub. Date: May 7, 2020

(54) ENERGY STORAGE SYSTEMS AND METHODS FOR FAULT MITIGATION

(71) Applicant: S&C Electric Company, Chicago, IL (US)

(72) Inventors: Kleber V.C. Facchini, Sussex, WI (US); William Wayne Buckner, Albuquerque, NM (US); Stephen Ebert Williams, Caledonia, WI (US); Benjamin Mayer Stocks, Milwaukee, WI (US)

(73) Assignee: S&C Electric Company, Chicago, IL (US)

(21) Appl. No.: 16/667,386

(22) Filed: Oct. 29, 2019

Related U.S. Application Data
(60) Provisional application No. 62/756,281, filed on Nov. 6, 2018.

(51) Int. Cl. H02J 7/02; H02J 3/32; B60L 53/12; H02J 50/12; H02J 50/70; H02J 9/06

(52) U.S. Cl. CPC H02J 7/025; H02J 3/32; H02J 9/061; H02J 50/12; H02J 50/70; B60L 53/12

(57) ABSTRACT

Electrical systems and related operating methods are provided. One exemplary electrical system includes a power conversion system, a plurality of battery strings, a plurality of switching arrangements configured electrically in series between the respective battery strings and an interface to the power conversion system, and a control system coupled to the plurality of switching arrangements. The switching arrangements are operated to electrically connect a selected one of the battery strings to the power conversion system while concurrently isolating remaining battery strings from the power conversion system and the selected battery string.

### CROSS-REFERENCE TO RELATED APPLICATION

This application claims the benefit of priority from the U.S. Provisional Application No. 62/756,281, filed on Nov. 6, 2018, the disclosure of which is hereby expressly incorporated herein by reference for all purposes.

### TECHNICAL FIELD

The subject matter described herein relates generally to electrical systems, and more particularly, to managing energy storage systems connected to an electrical grid.

### BACKGROUND

Advances in technology have led to substantial changes to electrical distribution systems as they evolve towards a so-called “smart grid” that supports distributed energy generation from solar, wind, and other distributed energy sources in a resilient and adaptive manner. To this end, energy storage systems are increasingly deployed to capture excess energy that may be subsequently discharged as desired. Lithium ion batteries are commonly utilized due to their availability and relatively low costs; however, their relatively low impedance can result in relatively high short-circuit currents in the event of a fault. In a typical deployment, as the energy level requirement increases, multiple batteries are connected in parallel to achieve the desired energy capability. This increases the potential amount of short-circuit current within the energy storage system, which, in turn, increases the maximum current handling capabilities required for fuses, switches, and other circuitry components, thereby increasing costs, and in some instances, components achieving such current handling may be infeasible. Accordingly, it is desirable to provide energy storage systems that are scalable and capable of supporting higher energy levels without compromising safety or entailing excessive component costs. Furthermore, other desirable features and characteristics of the present invention will become apparent from the subsequent detailed description and the appended claims, taken in conjunction with the accompanying drawings and the foregoing technical field and background.

### BRIEF SUMMARY

Electrical systems and related operating methods are provided. An exemplary electrical system includes a power conversion interface node, a plurality of energy storage subsystems, a plurality of switching arrangements, and a control system coupled to each of the plurality of switching arrangements. Each energy storage subsystem of the plurality of energy storage subsystems includes a plurality of energy storage arrangements configured electrically parallel to one another between a reference voltage node and a respective interface node of the respective energy storage subsystem. Each switching arrangement of the plurality of switching arrangements is configured electrically in series between the power conversion interface node and the respective interface node of the respective energy storage subsystem of the plurality of energy storage subsystems. The control system operates the plurality of switching arrangements to electrically connect the respective interface node of a first energy storage subsystem of the plurality of energy storage subsystems to the power conversion interface node while operating remaining switching arrangements of the plurality of switching arrangements to electrically isolate respective interface nodes of remaining energy storage subsystems of the plurality of energy storage subsystems from the power conversion interface node.

In another embodiment, a method of managing energy transfer in an energy storage system comprising a first energy storage subsystem and a second energy storage subsystem configured electrically parallel to the first energy storage subsystem is provided. The method involves initially operating, by a control system of the energy storage system, a first switching arrangement to electrically connect a first plurality of energy storage elements of the first energy storage subsystem to a power conversion interface node while concurrently operating a second switching arrangement to electrically isolate a second plurality of energy storage elements of the second energy storage subsystem from the power conversion interface node. Thereafter, the method continues with the control system operating the first switching arrangement to electrically isolate the first plurality of energy storage elements of the first energy storage subsystem from the power conversion interface node and operating the second switching arrangement to electrically connect the second plurality of energy storage elements of the second energy storage subsystem to the power conversion interface node while the first switching arrangement electrically isolates the first plurality of energy storage elements of the first energy storage subsystem from the power conversion interface node.

Another embodiment of an electrical system includes a power conversion system, a plurality of battery strings, a plurality of switching arrangements, wherein each switching arrangement of the plurality of switching arrangements is configured electrically in series between a respective battery string of the plurality of battery strings and an interface to the power conversion system, and a control system coupled to the plurality of switching arrangements to operate the plurality of switching arrangements to electrically connect one of the plurality of battery strings to the power conversion system while electrically isolating remaining battery strings of the plurality of battery strings from the power conversion system.

### BRIEF DESCRIPTION OF THE DRAWINGS

Embodiments of the subject matter will hereinafter be described in conjunction with the following drawing figures, wherein like numerals denote like elements, and wherein:

FIG. 1 is a schematic view of an electrical distribution system in one or more exemplary embodiments;

FIGS. 2-3 depict schematic views of an energy storage system suitable for use in an electrical distribution system in accordance with one or more exemplary embodiments; and

FIG. 4 is a flow diagram of an energy storage management process suitable for use with the electrical distribution system of FIG. 1 in an exemplary embodiment.

### DETAILED DESCRIPTION

Embodiments of the subject matter described herein relate to managing short-circuit current levels in an energy storage system that includes multiple energy storage arrangements configured electrically parallel to one another. In exemplary embodiments, individual energy storage arrangements are selectively connected to a power conversion system while other energy storage arrangements of the energy storage system are concurrently disconnected from the power conversion system and one another, thereby limiting the available short-circuit current that an individual energy storage arrangement may be exposed to in the event of a fault. This provides improved fault tolerance by limiting the propagation of potentially damaging fault currents within the energy storage system while also managing or reducing equipment costs by allowing for the use of components with lower current handling capabilities.

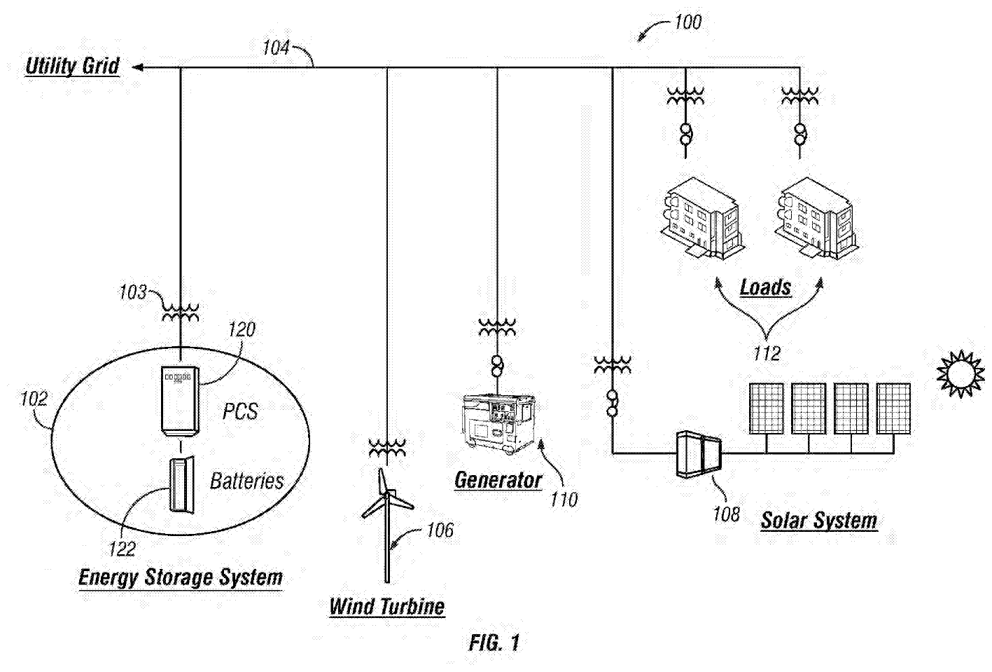

FIG. 1 depicts an exemplary embodiment of an electrical distribution system 100 that includes an energy storage system 102 that is coupled to an electrical grid 104 (e.g., via a transformer 103). The electrical grid 104 generally represents the distribution lines (or feeders), transformers, and other electrical components that provide an electrical interconnection between the energy storage system 102 and one or more external electrical power source(s) 106, 108, 110, which may be provided, for example, by a public utility or others. Accordingly, for purposes of explanation but without limitation, the electrical grid 104 may alternatively be referred to herein as the “utility grid;” however, the subject matter is not limited to traditional utility distribution systems, and in various embodiments, the electrical power source(s) 106, 108, 110 may include one or more additional microgrid systems, distributed energy sources, or the like. In the illustrated embodiment, one or more electrical loads 112 are also coupled to the electrical grid 104. The electrical loads 112 generally represent any devices, systems, components or appliances that receive electrical power from the electrical grid 104 for operation, such as, for example, one or more computer systems or other computing equipment (e.g., computers, servers, databases, networking components, or the like), medical equipment or devices, household appliances, or the like.

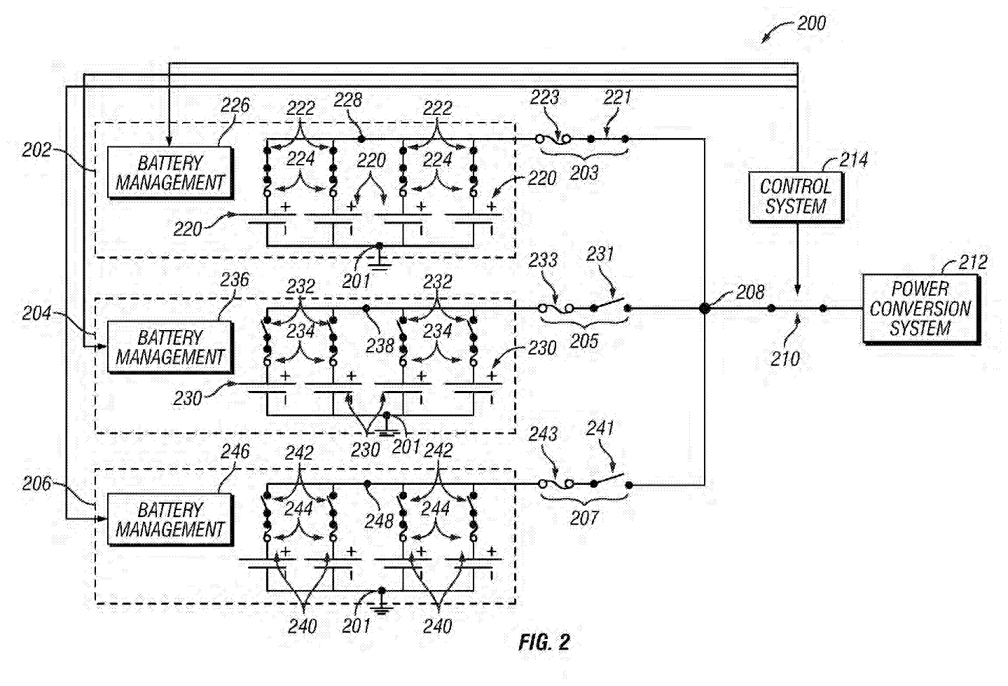

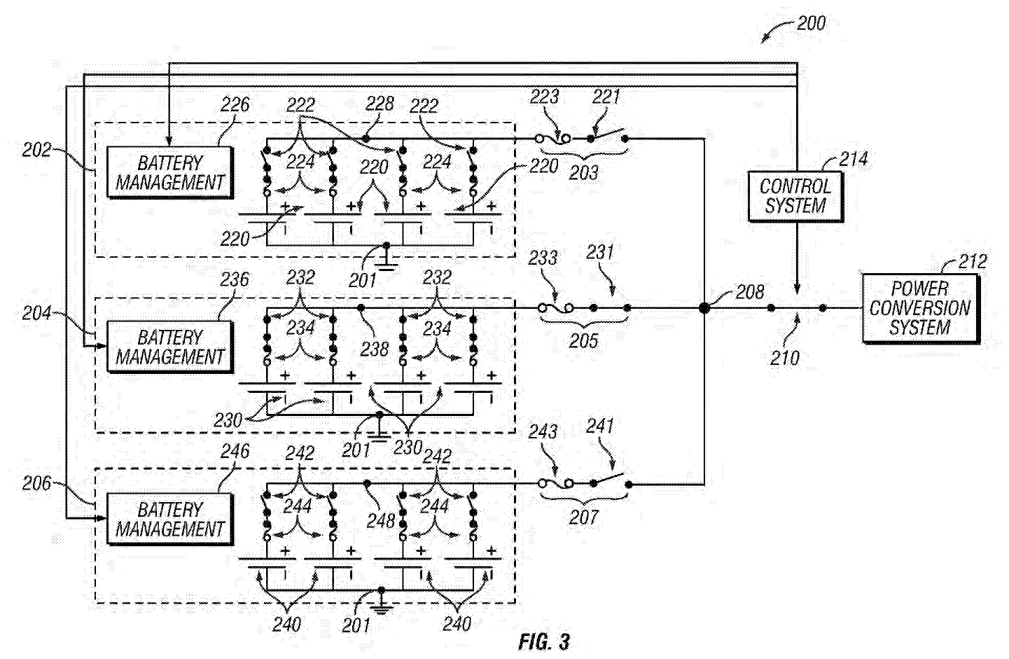

As described in greater detail below in the context of FIGS. 2-3, the energy storage system 102 generally includes a power conversion system 120 that is coupled between the grid 104 and an energy storage device architecture 122. The energy storage device architecture 122 generally represents a combination of batteries, capacitors, or other energy storage elements that are configured to achieve a desired energy storage capacity at a particular location on the grid 104. In exemplary embodiments, the energy storage architecture includes a number of energy storage subsystems configured electrically in parallel to one another, with the number of energy storage subsystems being chosen to achieve a desired energy storage capacity corresponding to the sum of the energy storage capacity of the individual energy storage subsystems. It should be noted that each energy storage subsystem may include any number of energy storage elements configured electrically in series and/or in parallel with one another to achieve a desired voltage, current, or energy storage capacity. As described in greater detail below in the context of FIGS. 2-3, in exemplary embodiments, each of the energy storage subsystems includes a number of battery racks configured electrically parallel to one another to achieve a desired energy rating at a particular voltage level corresponding to the interface with the power conversion system 120. For purposes of explanation, the energy storage subsystems may alternatively be referred to herein as a battery strings. However, it should be noted that the subject matter described herein is not necessarily limited to use with batteries, and other suitable energy storage elements may be utilized, as described in greater detail below. It should be noted that the number of battery racks influences the energy storage capacity of the individual battery strings, which, in turn influences the number of battery strings utilized to achieve the desired energy storage capacity for the energy storage device architecture 122.

The power conversion system 120 generally represents an inverter or other power converter and any related control modules capable of bidirectionally transferring energy from the grid 104 to the energy storage device architecture 122 (e.g., to charge the energy storage elements of the energy storage device architecture 122) or to the grid 104 from the energy storage device architecture 122 (e.g., to discharge the energy storage elements of the energy storage device architecture 122). For example, the power conversion system 120 could include a four-quadrant three-phase full bridge inverter capable of rectifying three-phase alternating current (AC) electrical signals at the interface to the electrical grid 104 to a direct current (DC) signal provided to the energy storage device architecture 122 when the energy storage device architecture 122 is receiving electrical energy from the electrical grid 104 (or charging), and conversely, is also capable of converting DC electric power from the energy storage device architecture 122 into corresponding three-phase AC output electric power at the interface to the electrical grid 104 when the energy storage device architecture 122 is providing electrical energy to the electrical grid 104 (or discharging).

The energy sources 106, 108, 110 generally represent any devices, systems, or components capable of generating electrical power that may be provided back to the grid 104, for example, to support operations of the electrical load(s) 112 or to deliver electrical power to the energy storage system 102. In the illustrated embodiment, the first energy source 106 is realized as one or more wind turbines configured to generate electrical energy in response to wind, the second energy source 108 is realized as one or more solar panels configured to generate electrical in response to solar energy, and the third energy source 110 is realized as an electrical generator. It should be noted that the foregoing is merely one exemplary arrangement of energy sources 106, 108, 110, and practical embodiments of the electrical distribution system 100 may include any type or number of wind turbines, solar panels or other photovoltaic components, electrical generators, fuel cells, batteries, or the like.

When the electrical power currently being generated by the energy sources 106, 108, 110 exceeds the demand or usage by the electrical loads 112 or other components coupled to the grid 104, the energy storage system 102 and/or the power conversion system 120 may be operated to charge the energy storage device architecture 122 and thereby store the excess energy. Conversely, when the demand or usage by the electrical loads 112 or other components coupled to the grid 104 exceeds the electrical power currently being generated by the energy sources 106, 108, 110, the energy storage system 102 and/or the power conversion system 120 may be operated to discharge the energy storage device architecture 122, and thereby supplement the energy generation by the energy sources 106, 108, 110 as may be necessary or desirable, as will be appreciated in the art.

It should be noted that FIG. 1 depicts a simplified representation of the electrical distribution system 100 for purposes of explanation and is not intended to be limiting. For example, in practice, the grid 104 or other components may be realized as three-phase electric systems, with corresponding wiring, lines, and other electrical components to support three-phase operation. Thus, although individual elements, connecting lines, or the like may be depicted in FIG. 1, practical embodiments of the electrical distribution system 100 may include such elements in triplicate, as will be appreciated in the art.

FIG. 2 depicts an exemplary embodiment of an energy storage system 200 suitable for use as the energy storage system 102 in the electrical distribution system 100 of FIG. 1. The illustrated energy storage system 200 includes an energy storage architecture that includes a plurality of energy storage subsystems 202, 204, 206 coupled to an interface node 208 and configured electrically in parallel with one another. Each of the energy storage subsystems 202, 204, 206 is selectively coupled to the interface node 208 via a respective fused switching arrangement 203, 205, 207 configured electrically in series between the respective energy storage subsystem 202, 204, 206 and the interface node 208. The interface node 208 is selectively connected to a power conversion system 212 (e.g., power conversion system 120) via a switching arrangement 210, and accordingly, for purposes of explanation but without limitation, the interface node 208 may alternatively be referred to herein as the power conversion interface node 208.

Each energy storage subsystem 202, 204, 206 includes a plurality of switched energy storage arrangements associated therewith, with the switched energy storage arrangements being configured electrically parallel to one another between a reference voltage node and a respective interface node for the respective energy storage subsystem 202, 204, 206. For example, the first energy storage subsystem 202 includes switched energy storage arrangements that each include a respective energy storage element 220 configured electrically in series with a respective switching element 222 and fuse 224 between an input/output interface node 228 of the first energy storage subsystem 202 and a ground reference voltage node 201. In exemplary embodiments, the energy storage elements 220 are realized as rechargeable batteries, such as lithium-ion batteries, having a series of battery cells in series and parallel to achieve the desired voltage and energy levels. For purposes of explanation but without limitation, the energy storage elements 220, 230, 240 may alternatively be referred to herein as batteries, and the switched energy storage arrangements configured electrically parallel to one another between a reference voltage node and a respective interface node may alternatively be referred to herein as battery racks which make up a battery string. That is, a battery rack includes an energy storage element 220, a switching element 222 and a fuse 224 configured in series. It should be noted that although FIG. 2 depicts each battery rack including an individual battery 220, 230, 240 in practice, multiple batteries may be configured electrically in series in each battery rack to achieve a desired energy level between the interface node 228 and the ground reference voltage node 201.

In exemplary embodiments, the switching elements 222 are realized as DC contactors; however, in alternative embodiments, other electrically-controlled switching elements may be utilized, such as, for example, breakers, relays, contactors, transistors, and/or the like. The fuses 224 may be realized as current-limiting fuses configured to limit the current through its associated switching element 222 and to/from its associated energy storage element 220. In exemplary embodiments, the fuses 224 are configured to limit the current to an amount that is less than a maximum current handling capability of the energy storage element 220 and/or the switching element 222.

Similar to the first energy storage subsystem 202, the other energy storage subsystems 204, 206 depicted in FIG. 2 include respective energy storage elements 230, 240 configured electrically in series with a respective switching element 232, 242 and fuse 234, 244 between an input/output interface node 238, 248 of the respective energy storage subsystem 204, 206 and the ground reference voltage node 201. In this regard, in one or more embodiments, the energy storage subsystems 202, 204, 206 are substantially identical to one another and include a common number and type of constituent components.

Each of the energy storage subsystems 202, 204, 206 also includes a respective control module 226, 236, 246 associated therewith. The energy storage subsystem control modules 226, 236, 246 are coupled to the switching elements 222, 232, 242 of the respective energy storage subsystem 202, 204, 206 and configured to operate the switching elements 222, 232, 242 to selectively enable or disable current flow to/from the energy storage elements 220, 230, 240 of the respective energy storage subsystem 202, 204, 206. For example, the control module 226 of the first energy storage subsystem 202 is coupled to the switching elements 222 to monitor current flow to/from the energy storage elements 220. As described in greater detail below, in one or more exemplary embodiments, the energy storage subsystem control modules 226, 236, 246 monitor the state of charge of the energy storage elements 220, 230, 240 and communicates the state of charge level of the energy storage elements 220, 230, 240 to the power conversion system 212. In this regard, although not illustrated in FIG. 2, practical embodiments of the energy storage subsystems 202, 204, 206 may include state of charge sensors, voltage sensors, current sensors, and the like to monitor the status of the energy storage elements 220, 230, 240 in real-time and broadcast its level to the power conversion system 212, which operates to regulate the condition of the energy storage elements 220, 230, 240, as described in greater detail below.

The energy storage subsystem control modules 226, 236, 246 may be implemented or realized with a processor, a controller, a microprocessor, a microcontroller, a content addressable memory, a digital signal processor, an application specific integrated circuit, a field programmable gate array, any suitable programmable logic device, discrete gate or transistor logic, processing core, discrete hardware components, or any combination thereof, and configured to carry out the functions, techniques, and processing tasks associated with the operation of the energy storage system 200 described in greater detail below. Furthermore, the steps of a method or algorithm described in connection with the embodiments disclosed herein may be embodied directly in hardware, in firmware, in a software module executed by the energy storage subsystem control module 226, 236, 246, or in any practical combination thereof. In accordance with one or more embodiments, the energy storage subsystem control module 226, 236, 246 includes or otherwise accesses a data storage element, such as a memory (e.g., RAM memory, ROM memory, flash memory, registers, a hard disk, or the like) or another suitable non-transitory short or long term storage media capable of storing computer-executable programming instructions or other data for execution that, when read and executed by the energy storage subsystem control module 226, 236, 246, cause the energy storage subsystem control module 226, 236, 246 to execute, facilitate, or perform one or more of the processes, tasks, operations, and/or functions described herein. For purposes of explanation but without limitation, the energy storage subsystem control modules 226, 236, 246 may alternatively be referred to herein as battery management control modules (or controllers) or battery management systems in the context of a plurality of battery strings comprised of a plurality of battery racks.

Still referring to FIG. 2, in exemplary embodiments, the fused switching arrangement 203, 205, 207 each include a switching element 221, 231, 241 and fuse 223, 233, 243 associated therewith that are configured electrically in series between the power conversion interface node 208 and the interface node 228, 238, 248 for the respective energy storage subsystems 202, 204, 206. Similar to the fused switching arrangements of the energy storage subsystems 202, 204, 206, in exemplary embodiments, the switching elements 221, 231, 241 are realized as contactors or similar electrically-controlled switching elements, and the fuses 223, 233, 243 are realized as current-limiting fuses configured to limit the current flow to/from a respective energy storage subsystem 202, 204, 206. In exemplary embodiments, the current limit of each respective fuse 223, 233, 243 is less than or equal to the sum of the current limits of the fuses 224, 234, 244 of its respective energy storage subsystem 202, 204, 206. For example, in the illustrated embodiment, the current limit for fuse 223 may be equal to four times the current limit of fuses 224. In this regard, it should be noted that as more parallel battery racks are included in an energy storage subsystem 202, 204, 206, the available short-circuit current increases, and thereby increases the current handling requirements for the inline fuse 223, 233, 243 used to connect the energy storage subsystem 202, 204, 206 to the power conversion interface node 208. Accordingly, the subject matter described herein manages the available short-circuit current within the energy storage system 200 to allow for more practical fuses 223, 233, 243 with lower current handling capabilities to be used, since costs, materials, packaging requirements, or other real-world constraints limit the availability of fuses 223, 233, 243 capable of achieving higher currents.

In one or more embodiments, each of the interface nodes 228, 238, 248 is realized as a bus bar arrangement or high current cabling connecting each energy storage rack of the respective energy storage subsystems 202, 204, 206. Additionally, the power conversion interface node 208 may be realized as a bus bar or cables that is coupled to the individual bus bars 228, 238, 248 of the energy storage subsystems 202, 204, 206 via the respective switching arrangements 203, 205, 207. The interface node 208 is coupled to the power conversion system 212 via the switching arrangement 210 configured electrically in series between the interface node 208 and the power conversion system 212. In exemplary embodiments, the switching arrangement 210 is realized as a contactor or another suitable electrically-controlled switching element having a current rating that is greater than or equal to that of fuses 223, 233, 243. As described above, in exemplary embodiments, the power conversion system 212 includes an inverter or other bidirectional power conversion module configured to convert DC electrical signals at the node 208 into AC electrical signals or DC electrical signals having a different voltage level associated therewith, and vice versa.

It should be noted that FIG. 2 is a simplified representation of the energy storage system 200, and practical embodiments of the energy storage system 200 may include any number of energy storage subsystems 202, 204, 206 arranged electrically in parallel with one another to provide a desired energy storage capability and/or current capability for the energy storage system 200. In this regard, it will be appreciated that adding additional energy storage subsystems 202, 204, 206 increases the amount of energy that may be stored and/or increases the amount of current that may be provided to the power conversion interface node 208. Similarly, each energy storage subsystem 202, 204, 206 may include any number of energy storage elements 220, 230, 240 to achieve a desired energy storage capability and/or current capability for the energy storage subsystems 202, 204, 206.

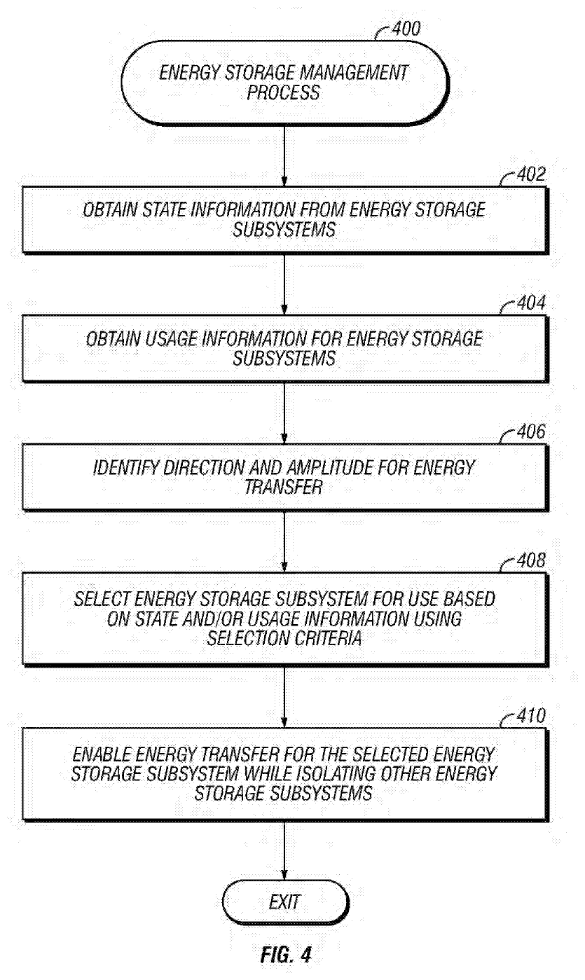

Still referring to FIG. 2, the energy storage system 200 includes a control system 214 that is coupled to the switching elements 221, 231, 241 for the respective energy storage subsystems 202, 204, 206 and configured to operate the switching elements 221, 231, 241 to manage which of the energy storage subsystems 202, 204, 206 is coupled to the power conversion interface node 208 and which of the remaining energy storage subsystems 202, 204, 206 are electrically isolated from the power conversion interface node 208, as described in greater detail below in the context of FIGS. 3-4. In this regard, FIG. 2 depicts a state of the energy storage system 200 where the control system 214 activates, closes, or otherwise enables the switching element 221 to electrically connect the energy subsystem interface node 228 to the power conversion interface node 208 while deactivating, opening, disabling or otherwise operating the switching arrangements 231, 241 to electrically isolate the energy subsystem interface nodes 238, 248 from the power conversion interface node 208. In such a configuration, current flow between the first energy storage subsystem 202 and the power conversion system 212 may be achieved while isolating the remaining energy storage subsystems 204, 206 from any potential faults within the energy storage system 200. In this regard, the energy storage subsystems 204, 206 are prevented from potentially providing excess current in the event of a fault condition within the first energy storage subsystem 202 or elsewhere within the energy storage system 200.

In exemplary embodiments, in concert with operating the switching elements 221, 231, 241, the control system 214 also commands, signals, or otherwise instructs the subsystem control modules 226, 236, 246 to operate their respective switching elements 222, 232, 242 in a corresponding manner. For example, for the state depicted in FIG. 2, the control system 214 commands, signals, or otherwise instructs the first subsystem control module 226 to activate, close or otherwise enable switching elements 222 to allow for current flow to/from the energy storage elements 220 when the first subsystem switching element 221 is closed or otherwise activated. In the discharge mode, as the energy level of the battery string 202 reaches a minimum threshold value (e.g., a minimum state of charge), the battery management control module 226 notifies or otherwise alerts the control system 214, which in turn initiates disconnection of the battery string 202 to prevent further discharging below the minimum threshold value. In one embodiment, the control system 214 opens the switching element 221 and commands the battery management control module 226 to open the switching elements 222. After the switching elements 221, 222 have been opened, the control system 214 commands one of the other battery management control modules 236, 246 to close its associated switching elements 232, 242 before closing the respective switching element 231, 241 to enable current flow from the selected battery string 204, 206. In this regard, only one of the battery strings 202, 204, 206 is electrically connected to the power conversion interface node 208 at a given point in time.

Depending on the embodiment, the control system 214 may be implemented or realized with a processor, a controller, a microprocessor, a microcontroller, a content addressable memory, a digital signal processor, an application specific integrated circuit, a field programmable gate array, any suitable programmable logic device, discrete gate or transistor logic, processing core, discrete hardware components, or any combination thereof, and configured to carry out the functions, techniques, and processing tasks associated with the operation of the energy storage system 200 described in greater detail below. Furthermore, the steps of a method or algorithm described in connection with the embodiments disclosed herein may be embodied directly in hardware, in firmware, in a software module executed by the control system 214, or in any practical combination thereof. In accordance with one or more embodiments, the control system 214 includes or otherwise accesses a data storage element, such as a memory (e.g., RAM memory, ROM memory, flash memory, registers, a hard disk, or the like) or another suitable non-transitory short or long term storage media capable of storing computer-executable programming instructions or other data for execution that, when read and executed by the control system 214, cause the control system 214 to execute, facilitate, or perform one or more of the processes, tasks, operations, and/or functions described herein. As described in greater detail below, in some embodiments, the control system 214 may include or be coupled to a data storage element utilized to store or otherwise maintain state and usage information associated with the energy storage subsystems 202, 204, 206 along with one or more cost functions or other selection criteria that a may be utilized to identify which energy storage subsystem 202, 204, 206 should be connected to and/or disconnected from the power conversion interface node 208.

FIG. 3 depicts another state of the energy storage system 200 where the control system 214 activates, closes, or otherwise enables the switching arrangement 231 to electrically connect the second energy subsystem interface node 238 to the power conversion interface node 208 while deactivating, opening, disabling or otherwise operating the switching elements 221 to electrically isolate the first energy subsystem interface node 228 from the power conversion interface node 208. For example, the first subsystem control module 226 may monitor the state of charge or other characteristics of the energy storage elements 220 to detect, identify, or otherwise determine when the energy storage subsystem 202 should cease the current energy transfer, and in response to that determination, operate the switching elements 222 to disconnect the energy storage elements 220 from the interface node 228 and provide an indication to the control system 214 to disconnect the first energy storage subsystem 202 from the power conversion interface node 208. For example, if the average or nominal state of charge across the energy storage elements 220 is less than or equal to a minimum state of charge (or the voltage between nodes 201 and 228 is less than a minimum voltage threshold value) while the power conversion system 212 is being operated to discharge energy from the first energy storage subsystem 202 (e.g., to the grid 104), the first subsystem control module 226 may determine the first energy storage subsystem 202 should be disconnected to stop discharging energy and maintain a desired state of charge for the energy storage elements 220 of the first energy storage subsystem 202. Similarly, if the first energy storage subsystem 202 is being charged or is otherwise being utilized to store excess energy available on the grid 104, the first subsystem control module 226 may determine the first energy storage subsystem 202 should be disconnected to prevent overcharging when the average or nominal state of charge across the energy storage elements 220 is greater than or equal to a maximum state of charge (or the voltage between nodes 201 and 228 is greater than a maximum voltage threshold value).

In response to receiving indication to disconnect the first energy storage subsystem 202, the control system 214 deactivates or otherwise opens the switching element 221 to electrically disconnect and isolate the first energy subsystem interface node 228 from the power conversion interface node 208. As described in greater detail below in the context of FIG. 4, in exemplary embodiments, the control system 214 receives feedback information from the other energy storage subsystem control modules 236, 246 and selects or otherwise identifies which of the other energy storage subsystems 204, 206 should be connected to the power conversion interface node 208 based on one or more selection criteria. In the illustrated embodiment of FIG. 3, in response to determining the second energy storage subsystem 204 should be connected, the control system 214 commands, signals, or otherwise instructs the second subsystem control module 236 to activate, close or otherwise enable switching elements 232 to allow for current flow to/from the energy storage elements 230 and activates, closes, or otherwise operates the switching element 231 to allow for current flow to/from the second subsystem interface node 238 from/to the power conversion interface node 208. In one or more embodiments, the control system 214 delays closing the switching element 231 until receiving feedback from the second subsystem control module 236 that indicates the switching elements 232 have been closed while also confirming the switching elements 222, 242 of the other energy storage subsystems 202, 206 and the corresponding switching elements 221, 241 for the other energy storage subsystems 202, 206 are all open prior to closing the switching element 231, thereby ensuring the energy storage elements 220, 240 of the other energy storage subsystems 202, 206 are maintained isolated from the energy storage elements 230 to protect against potential excess current in the event of a short-circuit fault within the second energy storage subsystem 204 when the switching element 231 is closed.

FIG. 4 depicts an exemplary embodiment of an energy storage management process 400 suitable for use with an energy storage system 200 to manage energy transfer to/from the energy storage system 200 while mitigating potential short-circuit fault conditions. The various tasks performed in connection with the illustrated process 400 may be implemented using hardware, firmware, software executed by processing circuitry, or any combination thereof. For illustrative purposes, the following description may refer to elements mentioned above in connection with FIGS. 1-3. In practice, portions of the energy storage management process 400 may be performed by different elements of the energy storage system 102, 200. It should be appreciated that the energy storage management process 400 may include any number of additional or alternative tasks, the tasks need not be performed in the illustrated order and/or the tasks may be performed concurrently, and/or the energy storage management process 400 may be incorporated into a more comprehensive procedure or process having additional functionality not described in detail herein. Moreover, one or more of the tasks shown and described in the context of FIG. 4 could be omitted from a practical embodiment of the energy storage management process 400 as long as the intended overall functionality remains intact.

In exemplary embodiments, the energy storage management process 400 is performed whenever it is determined that one battery string of an energy storage system should be disconnected from the power conversion interface node to select another battery string for connecting to the power conversion interface node. In this regard, the energy storage management process 400 may be initiated by the control system 214 in response to receiving an indication from one of the battery management control modules 226, 236, 246 that the respective battery string 202, 204, 206 should be disconnected (e.g., due to the state of charge of its respective batteries 220, 230, 240 reaching a threshold). Additionally, in some embodiments, the energy storage management process 400 may be initiated or performed whenever the direction and amplitude of energy transfer to/from the electrical grid 104 changes. In this regard, in some embodiments, the power conversion system 212 may be operated or commanded by another device external to the energy storage system 200, with the power conversion system 212 (or the external device) providing indication to the control system 214 of what state the power conversion system 212 is in (e.g., whether the energy storage system 200 should be charging from the grid or discharging to the grid and the appropriate energy level).

Referring to FIG. 4 with continued reference to FIGS. 1-3, in the illustrated embodiment, the energy storage management process 400 initializes or begins by receiving or otherwise obtaining state information from the battery strings (tasks 402). In this regard, the control system 214 may receive or otherwise obtain, from the battery management control module 226, 236, 246 of each battery string 202, 204, 206, information characterizing the current state of the components of the battery string 202, 204, 206, such as, for example, indication of the current state of charge or configuration of the switching elements 222, 232, 242 of the respective battery string 202, 204, 206, the voltage at the respective subsystem interface node 228, 238, 248, and/or information quantifying or characterizing the current condition of the batteries 220, 230, 240 of the respective battery string 202, 204, 206 (e.g., the current state of charge of the individual batteries 220, 230, 240, the average state of charge across the batteries 220, 230, 240 of the respective battery string 202, 204, 206, etc.). Additionally, in the event of a fault condition within a battery string 202, 204, 206, the battery management control module 226, 236, 246 of the respective battery string 202, 204, 206 may provide indication of the particular components that exhibited a fault condition or were otherwise affected by a potential fault condition, such as, for example, indication of the respective fuses 224, 234, 244 that have blown, indication of any switching elements 222, 232, 242 and/or batteries 220, 230, 240 that may have been affected, and the like.

In exemplary embodiments, the energy storage management process 400 also receives or otherwise obtains usage information for the battery strings (tasks 404). In this regard, the usage information quantifies or otherwise characterizes the amount and/or manner in which each of the battery strings 202, 204, 206 has been utilized to transfer energy to/from the power conversion interface node 208. For example, the usage information may include, for each respective battery string 202, 204, 206, the total number of times the respective battery string 202, 204, 206 has been utilized (e.g., the number of times the respective subsystem switching element 221, 231, 241 has been closed), number of times the respective battery string 202, 204, 206 has been utilized to discharge energy from the respective batteries 220, 230, 240 to the power conversion interface node 208, the number of times the respective battery string 202, 204, 206 has been utilized to charge the respective batteries 220, 230, 240 with energy from the power conversion interface node 208. Additionally, the usage information may include the cumulative durations of time that the respective battery strings 202, 204, 206 have been utilized to charge or discharge energy, the average duration of time during which the respective battery string 202, 204, 206 is connected to the power conversion interface node 208, the average magnitude of current flowing to/from the respective battery string 202, 204, 206 when connected to the power conversion interface node 208, and the like. The usage information may also include information characterizing the durations of time between instances when the respective battery string 202, 204, 206 is connected to the power conversion interface node 208 and an indication of when the respective battery string 202, 204, 206 was most recently connected to the power conversion interface node 208.

In exemplary embodiments, the usage information may be stored or otherwise be maintained by the control system 214 monitoring operation of the energy storage system 200. For example, the control system 214 may maintain a log of the operations of the respective switching elements 221, 231, 241 and corresponding directions of current flow to/from the respective battery strings 202, 204, 206. In this regard, although not illustrated in FIGS. 2-3, practical embodiments of the energy storage system 200 may include current sensing arrangements that are coupled to the control system 214 and configured to support monitoring current flow to/from the respective battery strings 202, 204, 206 and tracking the relative usage of the respective battery strings 202, 204, 206 in terms of the amount of current flow.

After obtaining state and usage information for the battery strings, the energy storage management process 400 identifies or otherwise determines the current direction and amplitude of energy transfer for the energy storage system and then selects or otherwise identifies the battery string to be utilized based on the state and/or usage information and the current energy transfer direction (tasks 406, 408). In this regard, the control system 214 identifies whether the power conversion system 120, 212 will be operated to deliver energy from the energy storage system 102, 200 to the grid 104, or whether the power conversion system 120, 212 will deliver excess energy from the grid 104 to the energy storage system 102, 200. Based on the identified direction of energy flow at the power conversion interface node 208, the control system 214 identifies or otherwise determines the battery string 202, 204, 206 to be utilized for that direction of current flow. For example, when the current flow at the power conversion interface node 208 corresponds to discharging energy from the energy storage system 102, 200 to the grid 104, the control system 214 may select or otherwise identify the battery string 202, 204, 206 having the highest state of charge metric(s) associated therewith. Conversely, when the current flow at the power conversion interface node 208 corresponds to charging the energy storage system 102, 200 with excess energy from the grid 104, the control system 214 may select or otherwise identify the battery string 202, 204, 206 having the lowest state of charge metric(s) associated therewith. Additionally, in one or more exemplary embodiments, the control system 214 implements selection logic involving one or more selection criteria to select the battery string 202, 204, 206 based on the state information and the usage information. For example, the control system 214 may utilize the usage information in conjunction with the state information to more preferentially select a battery string 202, 204, 206 that is less recently or less frequently used relative to other battery strings 202, 204, 206 having similar state information. In this regard, in some embodiments, a cost function may be created and utilized to calculate a relative cost associated with utilizing a respective battery strings 202, 204, 206 as a function of its associated state and usage information variables (e.g., state of charge metrics, voltage levels, usage durations, etc.). In some embodiments, different cost functions may be utilized depending on the direction of current flow at the power conversion interface node 208, for example, to more preferentially select battery strings 202, 204, 206 having relatively lower state of charges when charging from the grid 104 and more preferentially select battery strings 202, 204, 206 having relatively higher state of charges when discharging energy to the grid 104.

After identifying the battery string to be utilized, the energy storage management process 400 activates or otherwise enables energy transfer to the selected battery string while isolating the other battery strings from the power conversion interface node (task 410). For example, referring to FIGS. 2-3, as described above, in response to determining that the second battery string 204 should be utilized, the control system 214 signals, commands, or otherwise operates the switching elements 221, 241 for the other battery strings 202, 206 to the opened or deactivated state to disable current flow to/from the other battery strings 202, 206 and ensures the switching elements 221, 241 are opened to isolate the other battery strings 202, 206 from the power conversion interface node 208 and the selected battery string 204 prior to signaling, commanding, or otherwise operating the switching element 231 to electrically connect the interface node 238 for the selected battery string 204 to the power conversion interface node 208. Thus, any fault conditions at or within the selected battery string 204 do not impact the other battery strings 202, 206 and the other battery strings 202, 206 will not contribute any current to a short-circuit fault condition at or within the selected battery string 204 or upstream of the power conversion interface node 208. As described above, in connection with operating the switching elements 221, 231, 241, the control system 214 may also communicate with the battery management control modules 226, 236, 246 to operate the switching elements 222, 232, 242 of the respective battery strings 202, 204, 206 in a corresponding manner.

It should be noted that although FIGS. 2-3 depict all of the battery racks of an individual battery string 202, 204 as being connected or disconnected concurrently, in practice, not all of the battery racks of a battery string 202, 204, 206 may be in the same connectivity state at all times. For example, upon initiating connection of a battery string 202, 204, 206 to the power conversion interface node 208, the control system 214 may also provide, to the respective battery management control module 226, 236, 246, an indication of the amount of current that is present, anticipated or otherwise desired at the power conversion interface node 208. Based on that amount of current, the respective battery management control module 226, 236, 246 may determine which subset of the batteries 220, 230, 240 should be connected to achieve that amount of current, and then operate the corresponding switching elements 222, 232, 242 to support the desired current flow. In this regard, the battery management control module 226, 236, 246 may attempt to minimize the number of batteries 220, 230, 240 that are currently connected to the power conversion interface node 208 and utilize state of charge metrics, usage metrics, or potentially other information characterizing the usage or condition of the respective batteries 220, 230, 240 when selecting or otherwise determining the subset of the batteries 220, 230, 240 to be utilized. In response to fault condition in one of the racks or the battery 220, 230, 240 of a respective rack reaching an upper or lower state of charge threshold, the battery management control module 226, 236, 246 may operate the corresponding switching element(s) 222, 232, 242 to disconnect that respective battery 220, 230, 240 and take a particular battery rack offline while connecting one or more other battery racks to maintain the desired level of current handling.

In one or more embodiments, the energy storage management process 400 may be continually repeated to dynamically adjust which battery string is being utilized in real-time based on the state and/or usage of the battery strings and/or the direction of energy flow to/from the energy storage system 102, 200. For example, when charging the energy storage system 102, 200 from the grid 104 (e.g., due to excess energy production by a renewable energy source 106, 108), the control system 214 may connect the battery string 202, 204, 206 having the lowest state of charge to the power conversion interface node 208 first until a state of charge metric associated with that respective battery string 202, 204, 206 reaches an upper state of charge threshold, before selecting another of the remaining battery strings 202, 204, 206 having the lowest state of charge among the remaining battery strings 202, 204, 206 and connecting the next selected battery string 202, 204, 206 to the power conversion interface node 208 until its associated state of charge metric(s) reach the upper state of charge threshold, and so on, until the energy transfer direction reverses or until all battery strings 202, 204, 206 have reached the upper state of charge threshold. When all battery strings 202, 204, 206 have reached the upper state of charge threshold, the control system 214 may determine that further charging of the energy storage system 102, 200 should not continue and may operate the switching elements 210, 221, 231, 241 (or command the battery management control modules 226, 236, 246 to operate switching elements 222, 232, 242) to concurrently disconnect all of the battery strings 202, 204, 206 until the energy transfer direction reverses. In some embodiments, the control system 214 may also operate the switching arrangement 210 to disconnect the power conversion system 212 from the power conversion interface node 208 until the energy transfer direction reverses.

Conversely, when energy demand at the grid 104 requires discharging energy from the energy storage system 102, 200 to the grid 104 (e.g., due to relatively low energy production by a renewable energy source 106, 108), the control system 214 may connect the battery string 202, 204, 206 having the highest state of charge to the power conversion interface node 208 first until a state of charge metric associated with that respective battery string 202, 204, 206 reaches a lower state of charge threshold, before selecting another of the remaining battery strings 202, 204, 206 having the highest state of charge among the remaining battery strings 202, 204, 206 and connecting the next selected battery string 202, 204, 206 to the power conversion interface node 208 until its associated state of charge metric(s) reach the lower state of charge threshold, and so on, until the energy transfer direction reverses or until all battery strings 202, 204, 206 have reached the lower state of charge threshold. Again, if all battery strings 202, 204, 206 have reached the lower state of charge threshold, the control system 214 may determine that further discharging of the energy storage system 102, 200 should not continue and may operate the switching elements 210, 221, 231, 241 (or command the battery management control modules 226, 236, 246 to operate switching elements 222, 232, 242) to concurrently disconnect all of the battery strings 202, 204, 206 until the energy transfer direction reverses. In some embodiments, the control system 214 may also operate the switching arrangement 210 to disconnect the power conversion system 212 from the power conversion interface node 208 until the energy transfer direction reverses.

When two or more battery strings 202, 204, 206 have substantially the same state of charge metric(s) or other state information, the control system 214 may utilize the usage information to select and connect the respective battery string 202, 204, 206 that has the least usage, that has experienced the least loading, was the least recently used to transfer energy in the current direction, and/or the like. In this regard, the control system 214 may operate the switching elements 221, 231, 241 (and/or command the battery management control modules 226, 236, 246 to operate switching elements 222, 232, 242) to attempt to achieve relatively uniform usage across all of the battery strings 202, 204, 206 while also attempting to achieve substantially the same state of charge or other condition(s) across all of the battery strings 202, 204, 206. Again, various different selection criteria or cost functions may be utilized to optimize usage of the battery strings 202, 204, 206, and the subject matter described herein is not intended to be limited to any particular manner for selecting among battery strings 202, 204, 206.

Still referring to FIGS. 2-4, in one or more exemplary embodiments, the energy storage management process 400 is also initiated or performed in response to a fault condition at or within one of the battery strings 202, 204, 206. For example, in response to a short-circuit fault in one or more racks of one of the battery strings 202, 204, 206, the respective battery management control module 226, 236, 246 may open all of its associated switching elements 222, 232, 242 to isolate the rack exhibiting the short-circuit fault from the other racks and also notify the control system 214 of the potential fault condition (e.g., via the state information at 402, generating an interrupt, etc.). In response, the control system 214 electrically disconnects the battery string 202, 204, 206 from the power conversion interface node 208 by operating the appropriate switching element 221, 231, 241 and selects another battery string 202, 204, 206 for use by excluding the faulted battery string 202, 204, 206 from consideration until its state information indicates that the fault condition no longer exists. In some embodiments, the control system 214 may operate the switching arrangement 210 to completely disconnect the power conversion system 212 from the power conversion interface node 208 to attempt to isolate the fault condition prior to reconnecting the power conversion system 212 to the power conversion interface node 208 before connecting the newly selected battery string 202, 204, 206 to the power conversion interface node 208. In this manner, a short-circuit fault condition may be isolated within an individual battery string 202, 204, 206 or back upstream of the power conversion interface node 208 (e.g., within the power conversion system 212 or on the grid 104), where fault protection devices may be able to isolate the fault before reconnecting other battery strings 202, 204, 206, thereby minimizing potential component damage in the energy storage system 102, 200.

It should be noted that although the subject matter may be described herein primarily in the context of only an individual battery string being connected to the power conversion interface node at any particular instant in time, in practice, more than one battery string may be concurrently connected to the power conversion interface node as needed to achieve a desired current or power capability. For example, in situations where a higher current is demanded by the grid 104 or is available from the grid 104, the control system 214 may selectively connect two or more battery strings 202, 204, 206 as needed to meet the real-time current requirements while maintaining one or more other battery strings 202, 204, 206 isolated from the power conversion interface node to minimize the potentially available short-circuit current. In this regard, once the current flow at the power conversion interface node 208 drops to a level that can be accommodated by fewer battery strings 202, 204, 206, the control system 214 may dynamically disconnect one or more battery strings 202, 204, 206 to minimize the number of energy storage elements 220, 230, 240 that are concurrently connected to the power conversion interface node 208. The energy storage management process 400 may be performed whenever the amount of current flow desired at the power conversion interface node 208 changes or whenever the amount of current flow to be provided to/from the grid 104 changes to dynamically select and minimize the number of battery strings 202, 204, 206 concurrently connected to the power conversion interface node 208 while also selecting the battery string(s) 202, 204, 206 to be connected based on the relative state of charge, usage, and potentially other metrics to optimize the management and/or utilization of the battery strings 202, 204, 206.

To briefly summarize, the subject matter described herein mitigates a potential fault condition by segregating and isolating battery strings from one another, thereby limiting the potential short-circuit current that could otherwise be contributed by other battery strings. Limiting the available short-circuit current reduces the likelihood of an excessive short-circuit current that could potentially damage non-sacrificial components (e.g., batteries, switches, etc.) before the various fuses or other sacrificial components are able to prevent current flow. For example, referring to FIGS. 2-3, if all switching elements 221, 222, 231, 232, 241, 242 were closed concurrently, twelve times the current rating of an individual battery rack would be available in the event of a short-circuit within one of the battery strings 202, 204, 206 (in addition to whatever additional current may be contributed by the power conversion system 212), which could potentially damage one or more batteries or switches within a particular battery string in the event of a short-circuit fault condition within the battery string as well as potentially damaging the switching element 221, 231, 241 and/or fuse 223, 233, 243 utilized to connect the battery string to the power conversion interface node 208. By limiting the number of battery strings that are concurrently connected to the power conversion interface node at any point in time, the fault tolerance of the energy storage system is improved. For example, if a fault or other defect occurs at an individual battery rack within a battery string, rather than the fault resulting in a potentially damaging current flow that damages other components or propagates a fault condition throughout the energy storage system, the fuse and/or switch for that battery rack may operate to prevent current or otherwise isolate that battery rack, thereby allowing the other battery racks of the string to be utilized or another battery string to be utilized. Thus, the energy storage system may be maintained online rather than being shut down for replacing or repairing multiple different components throughout the system. Costs may also be reduced by allowing for components with lower current ratings to be utilized, or otherwise avoiding the need for additional or more expensive components (e.g., isolating DC switches).

For the sake of brevity, conventional techniques related to electrical energy generation and distribution, electrical energy storage, overcurrent protection, switching, signaling, sensing, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

The foregoing description may refer to elements or components or features being “coupled” together. As used herein, unless expressly stated otherwise, “coupled” means that one element/node/feature is directly or indirectly joined to (or directly or indirectly communicates with) another element/node/feature, and not necessarily mechanically. Thus, although the drawings may depict one exemplary arrangement of elements with direct electrical connections, additional intervening elements, devices, features, or components may be present in an embodiment of the depicted subject matter. In addition, certain terminology may also be used in the following description for the purpose of reference only, and thus are not intended to be limiting. For example, the terms “first,” “second,” and other such numerical terms referring to structures do not imply a sequence or order unless clearly indicated by the context.

The foregoing detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any theory presented in the preceding background, brief summary, or the detailed description.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the subject matter in any way. Rather, the foregoing detailed description will provide those skilled in the art with a convenient road map for implementing an exemplary embodiment of the subject matter. It should be understood that various changes may be made in the function and arrangement of elements described in an exemplary embodiment without departing from the scope of the subject matter as set forth in the appended claims. Accordingly, details of the exemplary embodiments or other limitations described above should not be read into the claims absent a clear intention to the contrary.

What is claimed is:

1. An electrical system comprising:
a power conversion interface node;
a plurality of energy storage subsystems, wherein each energy storage subsystem of the plurality of energy storage subsystems comprises a plurality of energy storage arrangements configured electrically parallel to one another between a reference voltage node and a respective interface node of the respective energy storage subsystem;
a plurality of switching arrangements, wherein each switching arrangement of the plurality of switching arrangements is configured electrically in series between the power conversion interface node and the respective interface node of the respective energy storage subsystem of the plurality of energy storage subsystems; and
a control system coupled to each of the plurality of switching arrangements to operate the plurality of switching arrangements to electrically connect the respective interface node of a first energy storage subsystem of the plurality of energy storage subsystems to the power conversion interface node while operating remaining switching arrangements of the plurality of switching arrangements to electrically isolate respective interface nodes of remaining energy storage subsystems of the plurality of energy storage subsystems from the power conversion interface node.

2. The electrical system of claim 1, wherein each of the plurality of energy storage arrangements of the first energy storage subsystem comprises a respective energy storage element configured electrically in series with a respective switching element between the reference voltage node and the respective interface node of the first energy storage subsystem.

3. The electrical system of claim 2, wherein:
the first energy storage subsystem comprises a first management module coupled to each of the respective switching elements; and
the control system is coupled to the first management module to instruct the first management module to operate the respective switching elements to enable current flow to the respective energy storage elements prior to activating a first switching arrangement of the plurality of switching arrangements to electrically connect the respective interface node of the first energy storage subsystem to the power conversion interface node.

4. The electrical system of claim 2, wherein:
the first energy storage subsystem comprises a first management module coupled to each of the respective switching elements; and
the control system is coupled to the first management module to receive an instruction from the first management module to deactivate a first switching arrangement of the plurality of switching arrangements to electrically isolate the respective interface node of the first energy storage subsystem from the power conversion interface node.

5. The electrical system of claim 4, wherein the control system is configured to activate a second switching arrangement of the plurality of switching arrangements to electrically connect a second energy storage subsystem of the plurality of energy storage subsystems to the power conversion interface node after deactivating the first switching arrangement.

6. The electrical system of claim 5, wherein:
the second energy storage subsystem comprises a second management module coupled to a second plurality of switching elements associated with energy storage arrangements of the second energy storage subsystem; and
the control system is coupled to the second management module to instruct the second management module to operate the second plurality of switching elements to enable current flow to the second energy storage subsystem after deactivating the first switching arrangement and prior to activating the second switching arrangement.

7. A method of managing energy transfer in an energy storage system comprising a first energy storage subsystem and a second energy storage subsystem configured electrically parallel to the first energy storage subsystem, the method comprising:
operating, by a control system of the energy storage system, a first switching arrangement to electrically connect a first plurality of energy storage elements of the first energy storage subsystem to a power conversion interface node while concurrently operating a second switching arrangement to electrically isolate a second plurality of energy storage elements of the second energy storage subsystem from the power conversion interface node; and
thereafter:
operating, by the control system, the first switching arrangement to electrically isolate the first plurality of energy storage elements of the first energy storage subsystem from the power conversion interface node; and
operating, by the control system, the second switching arrangement to electrically connect the second plurality of energy storage elements of the second energy storage subsystem to the power conversion interface node while the first switching arrangement electrically isolates the first plurality of energy storage elements of the first energy storage subsystem from the power conversion interface node.

8. The method of claim 7, further comprising receiving, by the control system, indication to disconnect the first energy storage subsystem from a first management control module of the first energy storage subsystem while the first switching arrangement electrically connects the first plurality of energy storage elements of the first energy storage subsystem to the power conversion interface node, wherein operating the first switching arrangement to electrically isolate the first plurality of energy storage elements comprises the control system operating the first switching arrangement to electrically isolate the first plurality of energy storage elements in response to the indication from the first management control module.

9. The method of claim 8, further comprising the control system instructing a second management control module of the second energy storage subsystem to operate switching elements of the second energy storage subsystem to electrically connect the second plurality of energy storage elements of the second energy storage subsystem to the power conversion interface node.

10. The method of claim 8, further comprising selecting, by the control system, the second energy storage subsystem for use from among a plurality of energy storage subsystems coupled to the power conversion interface node and configured electrically parallel to one another prior to operating the second switching arrangement to electrically connect the second plurality of energy storage elements of the second energy storage subsystem to the power conversion interface node, wherein the plurality of energy storage subsystems includes the first energy storage subsystem and the second energy storage subsystem.

11. The method of claim 10, wherein selecting the second energy storage subsystem comprises selecting the second energy storage subsystem based at least in part on a state of charge metric associated with the second energy storage subsystem relative to state of charge metrics associated with remaining ones of the plurality of energy storage subsystems.

12. The method of claim 10, wherein selecting the second energy storage subsystem comprises selecting the second energy storage subsystem based at least in part on a usage metric associated with the second energy storage subsystem relative to usage metrics associated with remaining ones of the plurality of energy storage subsystems.

13. The method of claim 10, wherein selecting the second energy storage subsystem comprises selecting the second energy storage subsystem based at least in part on a direction of current flow at the power conversion interface node.

14. The method of claim 7, further comprising:
receiving, by the control system, first state information associated with the first energy storage subsystem from a first management control module of the first energy storage subsystem; and
determining, by the control system, that the first energy storage subsystem should be disconnected based at least in part on the first state information, wherein the control system operates the first switching arrangement to electrically isolate the first plurality of energy storage elements of the first energy storage subsystem from the power conversion interface node in response to determining that the first energy storage subsystem should be disconnected.

15. The method of claim 7, further comprising:
receiving, by the control system, second state information associated with the second energy storage subsystem from a second management control module of the second energy storage subsystem;
determining, by the control system, that the second energy storage subsystem should be connected based at least in part on the second state information, wherein the control system operates the first switching arrangement to electrically isolate the first plurality of energy storage elements of the first energy storage subsystem from the power conversion interface node and operates the second switching arrangement to electrically connect the second plurality of energy storage elements of the second energy storage subsystem to the power conversion interface node in response to determining that the second energy storage subsystem should be connected.

16. An electrical system comprising:
a power conversion system;
a plurality of battery strings;
a plurality of switching arrangements, wherein each switching arrangement of the plurality of switching arrangements is configured electrically in series between a respective battery string of the plurality of battery strings and an interface to the power conversion system; and
a control system coupled to the plurality of switching arrangements to operate the plurality of switching arrangements to electrically connect one of the plurality of battery strings to the power conversion system while electrically isolating remaining battery strings of the plurality of battery strings from the power conversion system.

17. The electrical system of claim 16, wherein each battery string of the plurality of battery strings comprises a plurality of battery racks configured electrically parallel to one another.

18. The electrical system of claim 17, wherein each battery rack of the plurality of battery racks comprises a respective battery configured electrically in series with a respective switching element and a respective fuse.

19. The electrical system of claim 18, wherein each battery string of the plurality of battery strings comprises a respective battery management control module coupled to the respective switching elements.

20. The electrical system of claim 19, wherein the control system is coupled to the respective battery management control module of the one of the plurality of battery strings and signals the respective battery management control module to operate the respective switching elements to enable current flow when the one of the plurality of battery strings is electrically connected to the power conversion system.

21. The electrical system of claim 20, herein the control system is coupled to the respective battery management control modules of the remaining battery strings of the plurality of battery strings and signals the respective battery management control modules of the remaining battery strings to operate their respective switching elements to disable current flow when the one of the plurality of battery strings is electrically connected to the power conversion system.

22. The electrical system of claim 16, wherein the control system selectively connects the one of the plurality of battery strings to the power conversion system while electrically isolating remaining battery strings of the plurality of battery strings from the power conversion system based at least in part on state information associated with the plurality of battery strings.

23. The electrical system of claim 22, wherein the state information includes one or more state of charge metrics.

24. The electrical system of claim 16, wherein the control system selectively connects the one of the plurality of battery strings to the power conversion system while electrically isolating remaining battery strings of the plurality of battery strings from the power conversion system based at least in part on usage information associated with the plurality of battery strings.

25. The electrical system of claim 16, wherein the control system selectively connects the one of the plurality of battery strings to the power conversion system while electrically isolating remaining battery strings of the plurality of battery strings from the power conversion system based at least in part on a direction of energy transfer at the interface to the power conversion system.
